(19) United States
(12) Patent Application Publication
(10) Pub. No.: US 2026/0187576 A1
(43) Pub. Date: Jul. 2, 2026

(54) PRIVACY-PROTECTING METHODS AND APPARATUSES FOR DETERMINING FEATURE EFFECTIVE VALUE OF BUSINESS DATA

(71) Applicant: ALIPAY (HANGZHOU) INFORMATION TECHNOLOGY CO., LTD., Hangzhou (CN)

(72) Inventors: Yingting Liu, Hangzhou (CN); Chaochao Chen, Hangzhou (CN); Li Wang, Hangzhou (CN)

(73) Assignee: ALIPAY (HANGZHOU) INFORMATION TECHNOLOGY CO., LTD., Hangzhou (CN)

(21) Appl. No.: 19/542,885

(22) Filed: Feb. 18, 2026

Related U.S. Application Data
(63) Continuation of application No. 18/517,425, filed on Nov. 22, 2023.
Application No. 18/517,425 is a continuation of application No. PCT/CN2022/091637, filed on May 9, 2022.

(30) Foreign Application Priority Data
May 24, 2021 (CN) 202110564443.3

(51) Int. Cl. G06Q 10/067; G06F 21/62

(52) U.S. Cl. CPC G06Q 10/067; G06F 21/6245

(57) ABSTRACT

This specification discloses methods, apparatus, devices, and systems for determining a feature effective value of business data. In one implementation, a method includes: obtaining a joint data share of a first participant based on joint data that includes feature values of a plurality of objects corresponding to a plurality of feature terms, obtaining a predictive value share and a model parameter share based on the joint data and a business prediction model, determining, through secure multi-party computation, a correlation data share corresponding to the plurality of participants, and determining, through a significance test method, an effective value of a feature term of the plurality of feature terms.

### CROSS-REFERENCE TO RELATED APPLICATIONS

This application is a continuation and claims the benefit of priority of U.S. application Ser. No. 18/517,425, filed on Nov. 22, 2023, which is a continuation of PCT Application No. PCT/CN2022/091637, filed on May 9, 2022, which claims priority to Chinese Patent Application No. 202110564443.3, filed May 24, 2021, all of which are hereby incorporated by reference in their entireties.

### TECHNICAL FIELD

One or more embodiments of this specification relate to the field of data security technologies, and in particular, to privacy-protecting methods and apparatuses for determining a feature effective value of business data.

### BACKGROUND

Data needed by machine learning usually relate to a plurality of platforms and a plurality of fields. For example, in a machine learning-based merchant classification analysis scenario, electronic payment platforms possess transaction flow data of merchants, electronic commerce platforms store sales data of the merchants, and banking institutions possess loan data of the merchants. To improve services, a plurality of parties often jointly train business prediction models while ensuring the privacy and security of business data.

As the amount of data increase, a feature dimension of the data become larger. These multidimensional feature data usually have some redundant information, which may affect the effect of machine learning and reduce the stability of a model. Therefore, the multidimensional feature data can be reduced in dimension based on feature effectiveness by removing redundant features that are not significant in improving model performance and transforming the redundant features into low-dimensional features with as little loss of an amount of information as possible.

Therefore, it is expected that there can be improved solutions that can determine the feature effectiveness as secure as possible without leaking private data.

### SUMMARY

One or more embodiments of this specification describe privacy-protecting methods and apparatuses for determining a feature effective value of business data, to determine an effective value of a feature term in business data distributed in a plurality of parties without leaking privacy data. Specific technical solutions are as follows:

According to the first aspect, one or more embodiments provide a privacy-protecting method for determining a feature effective value of business data, where the business data are distributed in a plurality of participants, joint data are constructed under hypothetical splicing of respective business data of the plurality of participants, and the joint data include feature values of a plurality of objects for a plurality of feature terms; and the method is performed by any first participant device and includes the following: A joint data share of a first participant is obtained, and predictive value shares that respectively correspond to the plurality of objects and model parameter shares that respectively correspond to the plurality of feature terms are obtained, where the predictive value shares and the model parameter shares are obtained based on a trained business prediction model; correlation data shares that respectively correspond to the plurality of participants, where the correlation data share includes correlation data between the plurality of feature terms are determined based on joint data shares and predictive value shares of the plurality of participants through interaction between a plurality of participant devices through secure multi-party computation; and an effective value, of a feature term that corresponds to a model parameter, in improving an effect of the business prediction model is determined based on model parameter shares of the plurality of participants and corresponding data in the correlation data shares through secure interaction between the plurality of participant devices by using a significance test method.

In an implementation, the step that a joint data share of a first participant is obtained includes the following: A splitting operation and a splicing operation are performed based on the business data of the plurality of participants through interaction with another participant device through additive secret sharing, so that the plurality of participants respectively obtain the joint data shares; and the joint data are obtained under hypothetical reconstruction of the joint data shares of the plurality of participants.

In an implementation, the business prediction model is obtained based on secure joint training of the respective joint data shares of the plurality of participants, and the business prediction model is used to perform business prediction on the object.

In an implementation, the step that predictive value shares that respectively correspond to the plurality of objects and model parameter shares that respectively correspond to the plurality of feature terms are obtained includes the following: A local model parameter share of the trained business prediction model is obtained on the first participant device; and the plurality of participants are respectively enabled to determine the predictive value shares of the objects based on the joint data shares of the plurality of participants and the trained business prediction model through interaction between the plurality of participant devices.

In an implementation, the correlation data include covariance matrix data, and the correlation data share includes a covariance matrix share; and the step that correlation data shares that respectively correspond to the plurality of participants are determined includes the following: Intermediate matrix shares that respectively correspond to the plurality of participants are determined based on the joint data shares and the predictive value shares of the plurality of participants and a function relation in the business prediction model; and intermediate matrix inverse shares that respectively correspond to the plurality of participants are computed based on the intermediate matrix shares of the plurality of participants, to obtain covariance matrix shares that respectively correspond to the plurality of participants.

In an implementation, the step that intermediate matrix shares that respectively correspond to the plurality of participants are determined includes the following: Hessian matrix shares that respectively correspond to the plurality of participants are determined as the intermediate matrix shares based on the joint data shares and the predictive value shares of the plurality of participants and a Hessian matrix expression obtained based on the function relation in the business prediction model, where the Hessian matrix expression includes a joint data matrix and a predictive value matrix.

In an implementation, the step that Hessian matrix shares that respectively correspond to the plurality of participants are determined includes the following: Corresponding multiplication of vector elements is performed on the predictive value shares of the plurality of participants based on an expression of the predictive value matrix through multiplicative secret sharing, so that the plurality of participants respectively obtain intermediate vector shares; construction is performed by using elements in the intermediate vector share of the first participant as diagonal elements, to obtain a diagonalized predictive value matrix share of the first participant; and the Hessian matrix shares that respectively correspond to the plurality of participants are determined based on the joint data shares and predictive value matrix shares of the plurality of participants and the Hessian matrix expression.

In an implementation, the step that the Hessian matrix shares that respectively correspond to the plurality of participants are determined based on the joint data shares and predictive value matrix shares of the plurality of participants and the Hessian matrix expression includes the following: A secure multiplication operation is respectively performed on column vectors in the joint data share with corresponding diagonal elements in the predictive value matrix share when the secure multiplication operation on the joint data shares with the predictive value matrix shares of the plurality of participants is computed.

In an implementation, the step that intermediate matrix inverse shares that respectively correspond to the plurality of participants are computed based on the intermediate matrix shares of the plurality of participants, to obtain covariance matrix shares that respectively correspond to the plurality of participants includes the following: Iterative computation is performed based on the intermediate matrix shares of the plurality of participants by using a secret sharing matrix inverse (SMI) algorithm, to obtain the covariance matrix shares that respectively correspond to the plurality of participants.

In an implementation, the step that an effective value of a feature term that corresponds to a model parameter, in improving an effect of the business prediction model is determined includes the following: Diagonal elements in the covariance matrix shares of the plurality of participants are used as variance shares that respectively correspond to a plurality of model parameters; for any one of the model parameters, a significance test value share of the first participant for the model parameter is determined by jointly performing a secure inverse square root operation through interaction between the plurality of participant devices based on the corresponding model parameter share of the first participant and the corresponding variance shares of the plurality of participants by using the secret sharing inverse square root (SNSI) algorithm and the significance test method; and an effective value of the feature term that corresponds to the model parameter is determined based on significance test value shares of the plurality of participants for the model parameter.

In an implementation, the method further includes: An effective value share of the first feature term is obtained, for any first feature term, from another participant device; and an effective value, of the first feature term, after reconstruction, is determined based on a local effective value share of the first feature term and the obtained effective value share.

In an implementation, the method further includes: A feature term whose effective value does not satisfy a predetermined condition is removed from the plurality of feature terms based on the effective value, so that the plurality of participants perform secure joint training on the business prediction model by using business data obtained after the feature term is removed.

In an implementation, the object includes one of a user, a product, or an event; the feature term includes at least one of the following: basic attribute information, association relationship information, interaction information, or historical behavior information; and the business prediction model is used to perform business prediction on the object.

In an implementation, the business prediction model is obtained based on a logistic regression model.

According to a second aspect, one or more embodiments provide a privacy-protecting apparatus for determining a feature effective value of business data, where the business data are distributed in a plurality of participants, joint data are constructed under hypothetical splicing of respective business data of the plurality of participants, and the joint data include feature values of a plurality of objects for a plurality of feature terms; and the apparatus is deployed in any first participant device and includes the following: an acquisition module configured to obtain a joint data share of a first participant, and obtain predictive value shares that respectively correspond to the plurality of objects and model parameter shares that respectively correspond to the plurality of feature terms, where the predictive value shares and the model parameter shares are obtained based on a trained business prediction model; an interaction module configured to determine, based on joint data shares and predictive value shares of the plurality of participants through interaction between a plurality of participant devices through secure multi-party computation, correlation data shares that respectively correspond to the plurality of participants, where the correlation data share includes correlation data between the plurality of feature terms; and a test module configured to determine, based on model parameter shares of the plurality of participants and corresponding data in the correlation data shares through secure interaction between the plurality of participant devices by using a significance test method, an effective value, of a feature term that corresponds to a model parameter, in improving an effect of the business prediction model.

In an implementation, the acquisition module obtains the joint data share of the first participant, including: a splitting operation and a splicing operation are performed based on the business data of the plurality of participants through interaction with another participant device through additive secret sharing, so that the plurality of participants respectively obtain the joint data shares; and the joint data are obtained under hypothetical reconstruction of the joint data shares of the plurality of participants.

In an implementation, the business prediction model is obtained based on secure joint training of the respective joint data shares of the plurality of participants, and the business prediction model is used to perform business prediction on the object.

In an implementation, the acquisition module obtains the predictive value shares that respectively correspond to the plurality of objects and the model parameter shares that respectively correspond to the plurality of feature terms, including: a local model parameter share of the trained business prediction model is obtained on the first participant device; and the plurality of participants are respectively enabled to determine the predictive value shares of the objects based on the joint data shares of the plurality of participants and the trained business prediction model through interaction between the plurality of participant devices.

In an implementation, the correlation data include covariance matrix data, and the correlation data share includes a covariance matrix share; and the interaction module includes the following: a determining submodule configured to determine, based on the joint data shares and the predictive value shares of the plurality of participants and a function relation in the business prediction model, intermediate matrix shares that respectively correspond to the plurality of participants; and a computation submodule configured to compute, based on the intermediate matrix shares of the plurality of participants, intermediate matrix inverse shares that respectively correspond to the plurality of participants, to obtain covariance matrix shares that respectively correspond to the plurality of participants.

According to a third aspect, one or more embodiments provide a computer-readable storage medium, storing a computer program, and when the computer program is executed by a computer, the computer is enabled to perform the method according to any one of the first aspect.

According to fourth aspect, one or more embodiments provide a computing device, including a memory and a processor, where the memory stores executable code, and the processor implements the method according to any one of the first aspect when executing the executable code.

According to the methods and the apparatuses provided in the embodiments of this specification, the plurality of participants are enabled to obtain the correlation data shares based on the joint data share of the first participant and predictive value shares, and a joint data share of another participant and predictive value shares through interaction between the plurality of participants through secure multi-party computation, to further determine, by using a model parameter share and a correlation data share, an effect value, of a feature term, in improving an effect of the model. The plurality of participants perform secure multi-party computation by using various data shares, where obtained data are also shares so that privacy data such as correlation data between feature terms are not reconstructed during processing, thereby improving the data privacy and security in the process.

### BRIEF DESCRIPTION OF DRAWINGS

To describe the technical solutions in some embodiments of this application more clearly, the following briefly describes the accompanying drawings needed for describing the some embodiments. Clearly, the accompanying drawings in the following description merely illustrate some embodiments of this application, and a person of ordinary skill in the art can derive other drawings from these accompanying drawings without creative efforts.

FIG. 1 is a schematic diagram illustrating an implementation scenario, according to one or more embodiments disclosed in this specification;

FIG. 2 is a schematic flowchart illustrating a privacy-protecting method for determining a feature effective value of business data, according to one or more embodiments;

FIG. 3 is a schematic flowchart illustrating computation in application of secret sharing matrix multiplication, according to one or more embodiments; and

FIG. 4 is a schematic block diagram illustrating a privacy-protecting apparatus for determining a feature effective value of business data, according to one or more embodiments.

### DESCRIPTION OF EMBODIMENTS

The following describes the solutions provided in this specification with reference to the accompanying drawings.

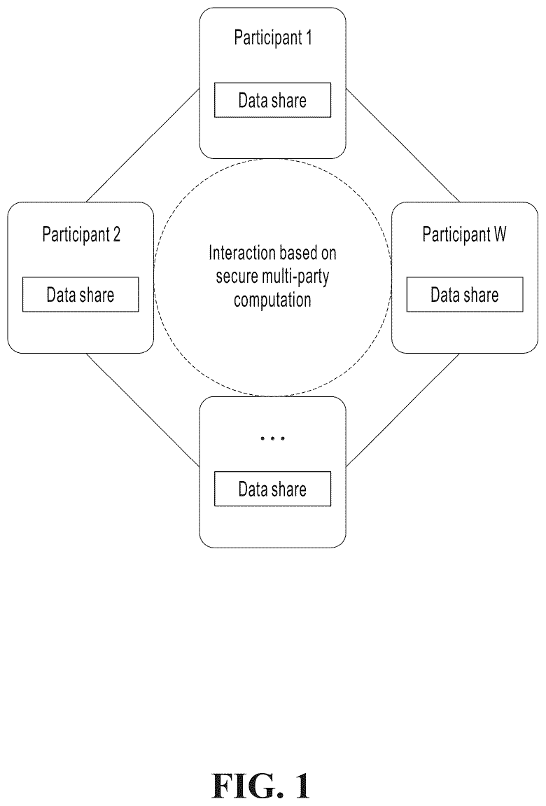

FIG. 1 is a schematic diagram illustrating an implementation scenario, according to one or more embodiments disclosed in this specification. As shown in FIG. 1, in a sharing learning scenario, a dataset is jointly provided (where W is a natural number) by a plurality of participants 1, 2, . . . , and W, where each participant possesses some data in the dataset that construct business data (namely, an original matrix) of the participant. The dataset can be a training dataset for training a model, a test dataset for testing a model, or a dataset to be predicted. The dataset can include feature data of an object, and the object can be one of various business objects to be analyzed such as a user, a product, and an event. The model can include a business prediction model trained through machine learning.

There are at least two types of distribution of data for the dataset. One type of distribution is that various participants possess different feature data of all objects. For example, each participant has the same N object samples, privacy data of each sample include D features, these features are distributed in W participants, and each participant possesses D/W features. For another example, two platforms have the same batch of users, but user features of business data of the platforms are different. Each participant possesses different types of features, and possesses the same quantity of features (where for example, each has D/W features) or different quantities of features. N, D, and W are all natural numbers. This is a scenario of vertical partitioning of the data in the dataset. Table 1 is distribution of business data in a vertical partitioning-of-data scenario.

TABLE 1

| | Participant 1 | | | | | | | Participant W | | |
|---|---|---|---|---|---|---|---|---|---|---|
| | Feature | Feature | | Participant 2 | | | | | | Feature |
| | 1 | 2 | . . . | . . . | . . . | . . . | . . . | . . . | . . . | D |
| Object | xx | xx | xx | xx | xx | xx | . . . | xx | xx | xx |
| 1 | | | | | | | | | | |
| Object | xx | xx | xx | xx | xx | xx | . . . | xx | xx | xx |
| 2 | | | | | | | | | | |
| . | xx | xx | xx | xx | xx | xx | . . . | xx | xx | xx |
| . | | | | | | | | | | |
| . | | | | | | | | | | |
| Object | xx | xx | xx | xx | xx | xx | . . . | xx | xx | xx |
| N | | | | | | | | | | |

xx represents a specific feature value, and belongs to privacy data of the participant. In Table 1, each row represents one piece of sample data, and each column represents a feature value of a certain feature term of N objects, where D feature terms respectively belong to W participants. feature values of D feature terms of the N objects construct all business data.

The other type of distribution is that the participants possess all feature data of different objects. For example, there are N object samples in total, business data of each sample include D feature terms, the N pieces of business data are distributed in W participants, each participant possesses some samples in all the N samples, and each sample includes the same feature term. Quantities of object samples stored by different participants can be the same or different. For another example, there are two banks that serve different user groups but possess the same user loan feature. This is a scenario of horizontal partitioning of the data in the dataset. Table 2 is distribution of business data in a horizontal partitioning-of-data scenario.

TABLE 2

| | | Feature | Feature | | | | | Feature |
|---|---|---|---|---|---|---|---|---|
| | | 1 | 2 | . . . | . . . | . . . | . . . | D |
| Participant 1 | Object 1 | xx | xx | xx | xx | xx | xx | xx |
| | Object 2 | xx | xx | xx | xx | xx | xx | xx |
| | . . . | xx | xx | xx | xx | xx | xx | xx |
| Participant 2 | . . . | xx | xx | xx | xx | xx | xx | xx |
| | . . . | xx | xx | xx | xx | xx | xx | xx |
| | . . . | xx | xx | xx | xx | xx | xx | xx |
| . . . | . . . | . . . | . . . | . . . | . . . | . . . | . . . | . . . |
| Participant W | . . . | xx | xx | xx | xx | xx | xx | xx |
| | . . . | xx | xx | xx | xx | xx | xx | xx |
| | Object N | xx | xx | xx | xx | xx | xx | xx |

In Table 2, each row represents one piece of sample data, and each column represents a feature value of a certain feature term of N object, where N pieces of sample data respectively belong to W participants. Different participants possess different object samples. feature values of D feature terms of the N objects construct all business data.

Business data possessed by the participant can include a plurality of feature terms. The feature term of the object can include at least one of the following: basic attribute information, association relationship information, interaction information, historical behavior information, etc. of the object. For example, when the object is a user, basic attribute information thereof can include a gender, an age, an income, etc. of the user, association relationship information of the user can include another user, a company, a region, etc. that has an association relationship with the user, interaction information of the user can include information such as a click, a view, or participation in a certain activity of the user on a certain website, and historical behavior information of the user can include history of transaction behavior, payment behavior, purchase behavior, etc. of the user.

When the object is a product, basic attribute information thereof can include a category, an origin, a price, etc. of the product, association relationship information of the product can include a user, a store, another product, etc. that has an association relationship with the product, interaction information of the product can include an interaction feature between the user, the store, and the product, and historical behavior information of the product can include information about purchase, transfer, return, etc. of the product.

When the object is an event, the event can include a transaction event, a login event, a purchase event, a social event, etc. Basic attribute information of the event can be textual information used to describe the event, association relationship information can include text that has a relationship with the event in context, information about another event that has an association with the event, etc., and the historical behavior information can include record information of development and a change of the event in the time dimension.

The participant can correspond to different service platforms. The service platform can include various types of enterprises, institutions, organizations, etc. The business data are usually privacy data of the service platform, and need relatively high privacy and security to be maintained in a processing process. Regardless of the data distribution method, a feature value (namely, feature data) that corresponds to a feature term of an object thereof is private data and can be stored as a privacy data matrix. For the security of the private data, each participant needs to keep the private data thereof local, without outputting plaintext data and without performing plaintext aggregation.

To protect the private data of each participant from leakage, in an implementation, each participant can enable, through interaction with a third party by using a secure multi-party computing method by using a predictive value and an original matrix of the participant, the third party to obtain covariance matrix data that can represent correlation data between the plurality of feature terms. The third party determines, by using the covariance matrix data and a model parameter and by using a significance test method, an effective value, of a feature term that corresponds to the model parameter, in improving an effect of a business prediction model.

The covariance matrix data include specific privacy data. Therefore, performing further improvement on the covariance matrix data can improve the security of the privacy data. Referring to FIG. 1, in one or more embodiments of this specification, various participants store respective data shares, including respective joint data shares, predictive value shares that correspond to a plurality of objects, model parameter shares that correspond to a plurality of features, etc. A plurality of participant devices perform interaction based on secure multi-party computation, and determine, by using the joint data shares and the predictive value shares, correlation data shares that respectively correspond to the plurality of participants, where the correlation data share includes correlation data between the plurality of feature terms. The participants respectively determine, based on model parameter shares of the plurality of participants and corresponding data in the correlation data shares by using a significance test method, an effective value, of a feature term, in improving an effect of a business prediction model. The plurality of participants perform secure multi-party computation by using various data shares, where obtained correlation data are also shares so that privacy data such as correlation data between feature terms are not reconstructed, thereby improving the data privacy and security in a processing process.

In this specification, the plurality of participants have respective corresponding participant devices, and perform the operations in the embodiments of this specification by using the corresponding participant devices. The participant device includes but is not limited to any apparatus, device, platform, and device cluster that has a computation and processing capability. The following describes the embodiments of this application with reference to specific embodiments.

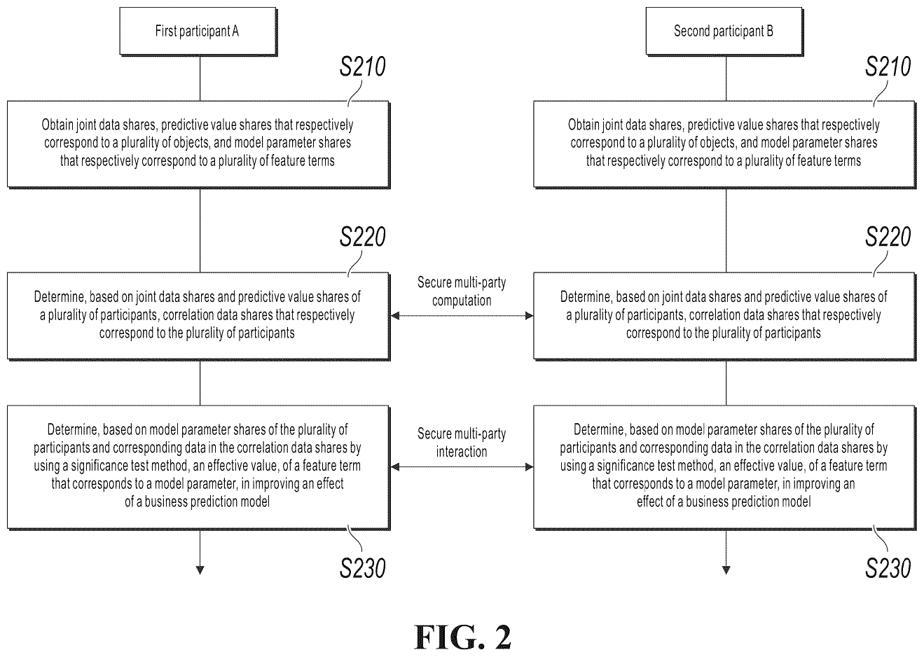

FIG. 2 is a schematic flowchart illustrating a privacy-protecting method for determining a feature effective value of business data, according to one or more embodiments. The business data are distributed in a plurality of participants, and joint data are constructed under hypothetical splicing of respective business data of the plurality of participants. The business data of the participant is privacy data with high privacy. The plurality of participants do not send the business data in plaintext, and do not perform real splicing on the business data to construct joint data. The joint data are only a dataset constructed by the business data of the plurality of participants in a hypothetical case. For example, Table 1 and Table 2 are respectively specific forms of joint data in a vertical partitioning-of-data scenario and a horizontal partitioning-of-data scenario. The joint data include feature values of a plurality of objects for a plurality of feature terms, and for example, can include feature values of N objects for D feature terms, where N and D are both natural numbers.

For ease of description, two participants are mostly used as an example for description in the following examples. For example, the two participants are respectively a first participant A and a second participant B, the first participant A corresponds to a first participant device, and the second participant B corresponds to a second participant device. The participant device is configured to perform an operation of a local participant, and store data of the local participant. In specific implementations, the participant device can alternatively obtain the data of the local participant from another device. The method in the embodiments specifically include step S210 to S230.

Step S210: The first participant device obtains a joint data share of the first participant A, and obtains predictive value shares that respectively correspond to a plurality of objects and model parameter shares that respectively correspond to a plurality of feature terms; and the second participant device obtains a joint data share of the second participant B, and obtains predictive value shares that respectively correspond to a plurality of objects and model parameter shares that respectively correspond to a plurality of feature terms.

The plurality of participants respectively possess respective business data. The business data are original data and are also privacy data. In a vertical partitioning scenario, the plurality of participants have different feature terms but same objects. The plurality of participants can respectively represent respective original data by using an original matrix. For example, an original matrix of the first participant A and an original matrix of the second participant B can be respectively represented as X_{A} and X_{B}, feature terms are respectively represented as d_{A}, d_{B}, and quantities of objects are respectively represented as n_{A} and n_{B}. In this case, a total feature term of the joint data is D=d_{A}+d_{B}, and a total quantity of objects or a total quantity of samples is N=n_{A}=n_{B}. When the column in the original matrix represents the feature term and the row represents the object or a sample, hypothetical horizontal splicing is performed on the business data of the plurality of participants such as the first participant A and the second participant B to obtain joint data with a form of X=(X_{A}, X_{B}). The above is a case that the column in the original matrix represents the feature term and the row represents the object or a sample, corresponding to a data distribution situation in Table 1. In other implementations, a column in an original matrix can represent an object and a row represents a feature term. In this case, hypothetical vertical splicing is performed on the business data of the plurality of participants such as the first participant A and the second participant B to obtain joint data with a form of

$$X = ( \begin{matrix}{X}_{A} \\ {X}_{B}\end{matrix} )$$

In a horizontal partitioning scenario, the plurality of participants have the same feature term but different objects. An original matrix of the first participant A and an original matrix of the second participant B are respectively X_{A} and X_{B}, feature terms are respectively d_{A}=d_{B}=D, and quantities of objects are respectively n_{A} and n_{B}. In this case, a total feature term of the joint data is D=d_{A}=d_{B}, and a total quantity of objects or a total quantity of samples is N=n_{A}+n_{B}. When the row in the original matrix of the participant represents the object and the column represents the feature term, hypothetical vertical splicing is performed on business data of the plurality of participants such as the first participant A and the second participant B to obtain joint data with a form of.

$$X = ( \begin{matrix}{X}_{A} \\ {X}_{B}\end{matrix} )$$

The above can correspond to a data distribution situation in Table 2. When the row in the original matrix represents the feature term and the column represents the object, hypothetical horizontal splicing is performed on the business data of the plurality of participants such as the first participant A and the second participant B to obtain joint data with a form of.

$$X = ( {X}_{A} , {X}_{B} )$$

To enable the plurality of participants to obtain joint data shares, the plurality of participants can split the business data of the participants into random numbers through additive secret sharing. Shares are completed through transfer of the random numbers between the plurality of participants. Specifically, the first participant device can perform a splitting operation and a splicing operation based on the business data of the plurality of participants through interaction with another participant device through additive secret sharing when obtaining the joint data share of the first participant A, so that the plurality of participants respectively obtain the joint data shares. Similarly, the second participant B also obtain the joint data share thereof.

The original matrix can be split into random matrices through additive secret sharing, and the shares can be completed through transfer of the random matrices between the plurality of participants. Two participants are used as an example. The first participant A and the second participant B respectively possess original matrices X_{A} and X_{B} of the business data. The first participant device can generate a random matrix R_{A} in a finite field and compute X_{A}−R_{A}=X₂. The first participant device can send any one, for example, X₂, of the two random matrices R_{A} and X₂, to the second participant device. The second participant device also generates a random matrix R_{B} in a finite field and computes X_{B}−R_{B}=X₃. The second participant device can send any one, for example, X₃, of the two random matrices R_{B} and X₃, to the first participant device.

The first participant device can splice R_{A} and received X₃ sent by the second participant device into a joint data share. The second participant device can splice R_{B} and received X₂ sent by the first participant device into a joint data share. Certainly, in actual application scenarios, there are usually three or more than three participants, and the above additive secret sharing implementation process can be easily extended to more than three parties. Data sent between the plurality of participants are all random matrices, and privacy data of the original matrices are not leaked.

Joint data are obtained under hypothetical reconstruction of the joint data shares of the plurality of participants. The reconstruction can be implemented based on the addition of the data shares of the parties. Specifically, the reconstruction can be implemented by adding another matrix transformation operation based on the addition, where matrix transformation includes, for example, multiplying by a predetermined value, and so on. The joint data include privacy data, and the participants do not directly perform plaintext aggregation on the privacy data. The joint data are merely a representation in a hypothetical case. In practice, the data shares of the participants are not directly reconstructed together. The following meanings about reconstruction are all applicable to the description here.

The joint data share of the first participant A can be represented by <X>_{A}, and the joint data share of the first participant B can be represented by <X>_{B}. In this case, joint data X=<X>_{A}+<X>_{B}, where <X> represents a share of a parameter X, and a subscript thereof represents a participant that the share belongs. For uniformity in expression, the form of “pointed brackets+subscripts” is used in the following to represent a share of data in a certain participant.

In the embodiments, the joint data share of the participant is obtained based on the business data of the plurality of participants, and a sum of the joint data shares of the plurality of participants is equal to the joint data in concept or in theory.

In step S210, the predictive value share and the model parameter share are data obtained based on a trained business prediction model. The business prediction model is a model obtained based on secure joint training performed on the respective joint data shares of the plurality of participants. The business prediction model can be obtained through pre-training. The business prediction model can be a model obtained through training based on a logistic regression model, or can be obtained through training based on another type of model. The business prediction model is used to perform business prediction on the object, and for example, can perform classification prediction or perform regression prediction on input feature data of the objects.

The plurality of participant devices can obtain predictive value shares and model parameter shares through the trained business prediction model. The first participant device can obtain a local model parameter share of the trained business prediction model on the first participant device, and respectively enable the plurality of participants to determine the predictive value shares of the objects based on the joint data shares of the plurality of participants and the trained business prediction model through secure interaction between the plurality of participant devices.

The plurality of participant devices use N objects in the joint data share as samples, to train a business prediction model. After the training, a model parameter share of the business prediction model on a local participant device can be obtained. The joint data shares of the plurality of participants are input into business prediction model through secure interaction between the plurality of participant devices so that each participant device can determine predictive value shares of the plurality of objects of a local participant.

Therefore, in data obtained by one participant, one object corresponds to one predictive value share, N objects respectively correspond to N predictive value shares, and the N predictive value shares can serve as vector elements to construct a vector; when business data include D feature terms, the trained business prediction model includes a plurality of model parameters that respectively correspond to the D feature terms. For any piece of predictive value data, the predictive value data are obtained under hypothetical reconstruction of corresponding predictive value shares possessed by the plurality of participants. For any one of the model parameters, the model parameter is obtained under hypothetical reconstruction of corresponding model parameter shares possessed by the plurality of participants.

Step S220: Determine, based on joint data shares and predictive value shares of the plurality of participants through interaction between a plurality of participant devices through secure multi-party computation, correlation data shares that respectively correspond to the plurality of participants, where the correlation data share includes correlation data between the plurality of feature terms.

The correlation data, to be specific, correlation data between the feature terms, are obtained under hypothetical reconstruction of the correlation data shares of the plurality of participants. The feature term includes correlation data, between feature terms, possessed by a same participant, further includes correlation data, between feature terms, possessed by different participants, includes correlation data between different feature terms, or includes correlation data between same feature terms.

When this step is implemented, the correlation data shares that respectively correspond to the plurality of participants can be determined, based on an existing equation for computing the correlation data between the feature terms, through secure multi-party computation by using the joint data shares and the predictive value shares. The equation that can indicate the correlation data between the feature terms can include a covariance matrix equation, a correlated coefficient equation, etc.

Secure multi-party computation (Secure Multi-party Computation, MPC) is an existing data privacy protection technology that can be used for multi-party participation, and specific implementations thereof include technologies such as homomorphic encryption, a garbled circuit, oblivious transfer, and secret sharing. The secure multi-party computation can be used to implement secure interaction computation for the joint data shares and the predictive value shares between the plurality of participant devices so that the plurality of participants can determine corresponding correlation data shares.

Step S230: Determine, based on model parameter shares of the plurality of participants and corresponding data in the correlation data shares through secure interaction between the plurality of participant devices by using a significance test method, an effective value, of a feature term that corresponds to a model parameter, in improving an effect of the business prediction model.

The significance test method can include a Wald test, a likelihood ratio (LR) test, a Lagrange multiplier (LM) test, etc. After the existing equation provided in the significance test method is transformed, effective value shares that correspond to the participants are determined by performing security computation on the model parameter shares of the plurality of participants and the correlation data shares through secure interaction between the plurality of participant devices.

In the embodiments, the feature term corresponds to the model parameter, and both the model parameter share and the correlation data share have data that separately correspond to the feature term. Significance test value shares that respectively correspond to the plurality of model parameters, namely, significance test value shares that correspond to the plurality of feature terms, can be determined by using the significance test method by using the corresponding data in the model parameter shares and the correlation data shares, and the effective value shares can be determined based on the significance test value shares.

When an effective value of a certain feature term needs to be determined, for example, for any first feature term, the first participant device can obtain an effective value share of the first feature term from another participant device, and determine, based on a local effective value share of the first feature term and the obtained effective value share, an effective value, of the first feature term, after reconstruction. The effective value of the feature term can alternatively be reconstructed in the second participant device or the another participant device. In the embodiments, an example in which the effective value is reconstructed in the first participant device is used only for description.

After obtaining the effective values of the plurality of feature terms, the first participant device can further remove, from the plurality of feature terms based on a plurality of effective values, a feature term whose effective value does not satisfy a predetermined condition, so that the plurality of participants perform secure joint training on the business prediction model by using business data obtained after the feature term is removed. The business data obtained after the feature term is removed realize the dimensionality reduction of the original matrix so that the feature terms are more refined while ensuring the security of private data without leakage.

The following describes in detail one or more specific embodiments. When the business prediction model includes a logistic regression model, and a Wald test method is used for the significance test method, a method of determining the correlation data shares in step S220 and a specific implementation of determining the effect value of the feature term in step S230 are provided.

The following first describes in detail an application principle of the Wald test on logical regression. When a logistic regression model is used to perform regression on feature data of a sample, a computation equation of the predictive value includes the following:

$$P ( y = 1 \vert X ) = π ( X ) = \frac{1}{1 + {e}^{- β X}} \qquad ( 1 )$$

$$P ( y = 0 \vert X ) = 1 - π ( X ) = \frac{1}{1 + {e}^{β X}}$$

X is the feature data of the sample and can be used as an independent variable; π(X) is a predictive value function of the sample and can be used as a dependent variable; β is a model parameter and is a coefficient of the feature term; e is a natural constant.

A null hypothesis and an alternative hypothesis of the Wald test are as follows:

H₀: ω_{J}=0 (j=1,2, . . . , k), that is, the independent variable does not affect an occurrence possibility of the dependent variable, that is, assume that the independent variable does not affect an estimated value of the dependent variable, where

$${H}_{1} \text{:} {ω}_{j} \neq 0$$

If the null hypothesis is rejected, it indicates that a change of the dependent variable depends on an independent variable j.

Test statistics of the Wald test are as follows:

$${Wald}_{k} = {( \frac{{\hat{β}}_{k}}{SE ( {\hat{β}}_{k} )} )}^{2} \qquad ( 2 )$$

Waldₖ is a significance test value and conforms to a chi-square distribution with a degree of freedom of 1. SE(\hat{β}ₖ) is a standard deviation of a model parameter \hat{β}ₖ and is also equal to a square root of diagonal elements of a covariance matrix, where

$$SE ( {\hat{β}}_{k} ) = {[ {( {H}^{- 1} )}_{kk} ]}^{\frac{1}{2}} \qquad ( 3 )$$

Diagonal elements of the covariance matrix are all variances of the feature terms. A covariance matrix Cov(\hat{β}) of the model parameters is a value of a negative Hessian (Hessian) matrix of the log-likelihood function at \hat{β}, where

$$Cov ( \hat{β} ) = {H}^{- 1} = {[ - \frac{{\partial }^{2} l ( β )}{\partial {β}^{2}} ]}_{\hat{β}} \qquad ( 4 )$$

$${H}_{kr} = \frac{{\partial }^{2} l ( β )}{\partial {β}_{k} \partial {β}_{r}} = {\sum }_{i = 1}^{N} {x}_{ik} π ( {X}_{i} ) [ π ( {X}_{i} ) - 1 ] {x}_{ir} \qquad ( 5 )$$

is an element expression of a Hessian matrix H. Natural numbers less than N can be used for both subscripts k and r. xᵢₖ and xᵢᵣ are elements in joint data X. Xᵢ represents feature data of an i^{th} sample.

From the derivation of the above equation, it can be seen that the matrix H can be expressed as H=X^{T}MX, where

$$X = ( \begin{matrix}{x}_{11} & {x}_{12} & ⋯ & {x}_{1 D} \\ {x}_{21} & {x}_{22} & ⋯ & {x}_{2 D} \\ ⋯ & ⋯ & ⋱ & ⋯ \\ {x}_{N 1} & {x}_{N 2} & ⋯ & {x}_{ND}\end{matrix} ) \qquad ( 6 )$$

$$( 7 )$$

$$M = ( \begin{matrix}π ( {X}_{1} ) [ π ( {X}_{1} ) - 1 ] & & & 0 & & ⋯ & 0 \\ 0 & & & π ( {X}_{2} ) [ π ( {X}_{2} ) - 1 ] & & ⋯ & 0 \\ & ⋯ & ⋯ & & ⋱ & & ⋯ \\ & 0 & 0 & & ⋯ & & π ( {X}_{N} ) [ π ( {X}_{N} ) - 1 ]\end{matrix} )$$

N is a total quantity of samples, that is, a total quantity of objects. D is a dimension of the feature data. π(X_{N}) is a predictive value of the logistic regression model for a sample X_{N}. M is a diagonal matrix obtained based on the predicted values and can also be referred to as a predictive value matrix.

From Equation (2)

$${Wald}_{k} = {( \frac{{\hat{β}}_{k}}{SE ( {\hat{β}}_{k} )} )}^{2}$$

it can be seen that, for a k^{th} model parameter, the larger the standard deviation of the model parameter, that is, the larger the value that corresponds to a k^{th} row and a k^{th} column in the covariance matrix, indicating that the model parameter makes the logistic regression model more oscillatory, the smaller the value of the Wald test that corresponds to the model parameter.

After the significance test value Waldₖ for the k^{th} model parameter is determined, statistics of zₖ can be further obtained according to:

$${Z}_{k} = \frac{{\hat{β}}_{k}}{SE ( {\hat{β}}_{k} )} \qquad ( 8 )$$

In addition, a corresponding p-value is computed according to p_value=2[1−norm.cdf(|zₖ|)], where the function norm.cdf is used to obtain a probability distribution function for the normal distribution. When the p-value is less than a significance level threshold, the null hypothesis is rejected, the model parameter can be retained for modeling, and 1 or another higher value can be used for an effective value of a feature term that corresponds to the model parameter; when the p-value is not less than the significance level threshold, the null hypothesis is accepted, the model parameter is not retained, and 0 or another lower value can be used for the effective value of the feature term corresponding to the model parameter. 0.05, 0.01, etc. can be usually used for the significance level threshold.

Logistic regression analysis is a statistical method of parsing the independent variable and the dependent variable and clarifying a relationship therebetween. The regression equation established is meaningful only if the independent variable and the dependent variable indeed have a certain relationship. Therefore, whether a factor used as the independent variable is correlated to a prediction object that is the dependent variable, to what degree of correlation, and to what degree of certainty that the correlation can be determined are problems to be resolved by regression analysis. The Wald test can be used for logistic regression analysis so that values of coefficients of regression terms are tested one by one. For specific independent variables, if the Wald test indicates that these independent variables are significant, the variables should be included in the model. If the Wald test indicates that these independent variables are not significant, the variables can be omitted from the model. Logistic regression analysis and the Wald test can be used to evaluate the model parameters of the business prediction model, and further filter a feature term of an object sample based on an evaluation result, to achieve downscaling of the business data.

In the embodiments, in step S220, the correlation data include the covariance matrix data, and the correlation data share includes the covariance matrix share. The covariance matrix can be constructed under hypothetical reconstruction of covariance matrix shares of the plurality of participants. The covariance matrix is a matrix constructed by covariances between pairs of feature terms of the plurality of feature terms in the joint data, where elements on a main diagonal are variances of the plurality of feature terms, and elements on an off-diagonal are covariances between pairs of feature terms. The covariance matrix is a symmetric matrix. When there are D feature terms in the joint data, the covariance matrix can be a symmetric matrix of D*D dimensions.

When the correlation data shares that respectively correspond to the plurality of participants are determined in step S220, that is, when the covariance matrix shares that respectively correspond to the plurality of participants are determined, the participant devices of the plurality of participants can perform step 1 and step 2 below.

Step 1: Determine, based on the joint data shares and the predictive value shares of the plurality of participants and a function relation in the business prediction model, intermediate matrix shares that respectively correspond to the plurality of participants. For example, the first participant A obtains an intermediate matrix share <H>_{A}, and the second participant B obtains an intermediate matrix share <H>_{B}. An intermediate matrix H is obtained under reconstruction of a plurality of intermediate matrix shares. The plurality of participants do not really perform the reconstruction of the intermediate matrix shares; here, it just represents a relationship between the plurality of intermediate matrix shares.

Step 2: Compute, based on the intermediate matrix shares of the plurality of participants, intermediate matrix inverse shares that respectively correspond to the plurality of participants, to obtain covariance matrix shares that respectively correspond to the plurality of participants. For example, the first participant A obtains an intermediate matrix inverse share <H⁻¹>_{A}, and the second participant B obtains an intermediate matrix inverse share <H⁻¹>_{B}. An inverse H⁻¹ of the intermediate matrix is obtained under reconstruction of a plurality of intermediate matrix inverse shares. The plurality of participants do not really perform the reconstruction of the intermediate matrix inverse shares; here, it just represents a relationship between the plurality of intermediate matrix inverse shares.

In step 1, that intermediate matrix shares that respectively correspond to the plurality of participants are determined can be the following: Hessian matrix shares that respectively correspond to the plurality of participants are determined as the intermediate matrix shares based on the joint data shares and the predictive value shares of the plurality of participants and a Hessian matrix expression obtained based on the function relation in the business prediction model, where the Hessian matrix expression includes a joint data matrix and a predictive value matrix.

When the business prediction model is a logistic regression model, the function relation of the business prediction model, that is, a function relation of the model predictive value, is shown in Equation (1) above. A corresponding model parameter, for example, 3, is obtained after the logistic regression model is trained. The Hessian matrix expression is actually a second derivative with respective to the model parameter β. Based on Equation (1) to Equation (5) above, it can be seen that the Hessian matrix expression obtained based on the function relation in the business prediction model is as follows:

$$H = {X}^{T} MX \qquad ( 9 )$$

The plurality of participants can respectively determine, based on the joint data shares <X> possessed by the plurality of participants respectively, and matrix M shares obtained based on a plurality of predictive value π(X_{N}) shares, the shares of H through secure interaction between the plurality of participant devices by using Equation (9) above. M can be referred to as a predictive value matrix.

In an application scenario, the joint data X are a high-dimensional matrix with a basic quantity of objects N usually in a range of one hundred thousand, one million or even more, leading to an excessive amount of interaction data and inefficient processing when H=X^{T} MX is computed by using share data of the plurality of participants. To simplify the computation of the shares of H, the interaction data between the plurality of participants are simplified as much as possible. A form of the matrix M can be transformed to simplify a process of determining the shares of H by the plurality of participants.

Specifically, when the first participant device determines the Hessian matrix shares <H> corresponding to the plurality of participants by using a joint data share <X>_{A}, a plurality of predictive value shares, and Equation (9) above, step 1a to step 3a can be performed below.

Step 1a: Perform corresponding multiplication of vector elements on the predictive value shares of the plurality of participants based on an expression of the predictive value matrix through multiplicative secret sharing, so that the plurality of participants respectively obtain intermediate vector shares.

For example, in the case of two participants, the first participant A and the second participant B can perform corresponding multiplication of vector elements on the predictive value share through multiplicative secret sharing, to obtain an intermediate vector share of the first participant A. An intermediate vector is obtained under hypothetical reconstruction of the intermediate vector shares of the plurality of participants. The plurality of participants do not really reconstruct the intermediate vector; here, it just represents a relationship between a plurality of intermediate vector shares.

Step 2a: Perform construction by using elements in the intermediate vector share of the first participant A as diagonal elements, to obtain a diagonalized predictive value matrix share of the first participant A.

As another participant device, the second participant device can also perform construction by using elements in the intermediate vector share of the second participant B as diagonal elements, obtain a diagonalized predictive value matrix share of the second participant B.

Step 3a: Determine, based on the joint data shares <X> of the plurality of participants, the predictive value matrix shares, and the Hessian matrix expression, the Hessian matrix shares that respectively correspond to the plurality of participants. For example, the first participant A and the second participant B can determine Hessian matrix shares <H>_{A} and <H>_{B} through, for example, secret sharing matrix multiplication.

Step 1a and step 2a above are performed so that the plurality of participants respectively obtain diagonalized predictive value matrix shares based on the plurality of predictive value shares of the plurality of participants. Since the main diagonal elements of the diagonalized matrix are not 0, the non-main diagonal elements are all 0. In this way, the predictive value matrix is simplified so that processing efficiency is improved.

In step 1a, an expression of the predictive value matrix M includes the following:

$$π ( {X}_{N} ) [ π ( {X}_{N} ) - 1 ] \qquad ( 10 )$$

Therefore, another expression of Equation (10) above can be obtained by utilizing the predictive value shares respectively possessed by the plurality of participants, for example, a predictive value share <π>_{A} of the first participant A and a predictive value share <π>_{B} of the second participant B:

$$( < π {>}_{A} + < π {>}_{B} ) * ( < π {>}_{A} + < π {>}_{B} - 1 ) = < intermediate vector {>}_{A} + < intermediate vector {>}_{B} \qquad ( 11 )$$

The plurality of participants can perform corresponding multiplication of vector elements through multiplicative secret sharing based on Equation (11). That is, for any group of predictive value shares between the plurality of participants, the group of predictive value shares are used as an input of multiplicative secret sharing, and multiplicative secret sharing is performed in a form of the predictive value matrix expression, to output elements in respective intermediate vector shares that the plurality of participants have. Elements that are in intermediate vector shares and that correspond to a plurality of groups of predictive value shares constitute the intermediate vector shares. The intermediate vector is obtained under hypothetical reconstruction of a plurality of intermediate vector shares.

For example, each predictive value share <π>_{A} of the first participant A and the corresponding predictive value share <π>_{B} of the second participant B can be used as the input of the multiplicative secret sharing, and multiplicative secret sharing is performed based on Equation (11), to output elements in an <intermediate vector>_{A} share that corresponds to the first participant A and elements in an <intermediate vector>_{B} share that corresponds to the second participant B.

In step 2a, the first participant A performs construction by using the elements in the <intermediate vector>_{A} share as diagonal elements to obtain a diagonal matrix <Λ>_{A} that is the diagonalized predictive value matrix share of the first participant A. The second participant B performs construction by using the elements in the <intermediate vector>_{B} share as diagonal elements, to obtain a diagonal matrix <Λ>_{B} that is the diagonalized predictive value matrix share. When the dimensionality of the <intermediate vector>_{A} share is N, the dimensionality of the diagonal matrix obtained through construction is N*N. When the diagonal matrix is constructed, the diagonal elements in the predictive value matrix share <Λ>_{A} are respectively elements in the <intermediate vector>_{A} share, and off-diagonal elements in the predictive value matrix share <Λ>_{A} are all 0.

In step 3a, the matrix M of the Hessian matrix expression H=X^{T}MX can be replaced with a predictive value matrix Λ. Therefore, the Hessian matrix expression can be updated to H=X^{T}ΛX. The first participant A and the second participant B can determine, based on H=X^{T}ΛX through secret sharing matrix multiplication (Secret Matrix Multiplication, SMM), the Hessian matrix share <H>_{A} of the first participant A and the Hessian matrix share <H>_{B} of the second participant B based on the joint data share <X>_{A} of the first participant A and the predictive value matrix share <Λ>_{A}, and based on the joint data share <X>_{B} of the second participant B and the predictive value matrix share <Λ>_{B}.

The predictive value matrix share is the diagonal matrix that includes a large quantity of 0 elements and the dimension of the matrix is N*N. In a business scenario, the magnitude of the sample N is quite large, for example, in the order of one hundred thousand, one million, or higher, that is, the dimensionality of the joint data X is quite high. When secret sharing matrix multiplication is performed for X^{T} and the diagonal matrix Λ, to improve performing efficiency and to reduce an amount of communication between the participants, a more concise method can be used in the computation of X^{T}Λ.

That is, a secure multiplication operation is respectively performed on column vectors in the joint data share with corresponding diagonal elements in the predictive value matrix share when the secure multiplication operation on the joint data shares with the predictive value matrix shares of the plurality of participants is computed.

The plurality of predictive value matrix shares are each a diagonal matrix, elements on a main diagonal is not 0, and elements on a non-main diagonal are each 0. When the matrix multiplication operation is performed on the joint data share with the predictive value matrix share, the joint data share can be split into column vectors of the joint data share so that the multiplication operation is respectively performed thereon with the diagonal elements in the predictive value matrix share, that is, a multiplication operation is performed on the column vectors with non-0 elements. Results of the multiplication operation of the column vectors with the 0 elements are all 0 can be omitted and are not computed. In this way, a high-dimensional matrix multiplication operation between the plurality of participants can be dismantled to save a large quantity of computations, thereby reducing an amount of communication between many participants. The amount of communication plays a decisive role in processing efficiency in a privacy protection scenario.

The following describes, with reference to the matrix expression, how the amount of communication is reduced during the multiplication operation of the column vectors with the non-0 elements. In the Hessian matrix expression H=X^{T}ΛX, a specific form of X^{T}Λ is as follows:

$${X}^{T} Λ = ( \begin{matrix}{x}_{11} & … & {x}_{N 1} \\ ⋮ & ⋱ & ⋮ \\ {x}_{1 D} & … & {x}_{ND}\end{matrix} ) ( \begin{matrix}{\hat{y}}_{1} ( {\hat{y}}_{1} - 1 ) & … & 0 \\ ⋮ & ⋱ & ⋮ \\ 0 & … & {\hat{y}}_{N} ( {\hat{y}}_{N} - 1 )\end{matrix} ) = ( \begin{matrix}{x}_{11} {\hat{y}}_{1} ( {\hat{y}}_{1} - 1 ) & … & {x}_{N 1} {\hat{y}}_{N} ( {\hat{y}}_{N} - 1 ) \\ ⋮ & ⋱ & ⋮ \\ {x}_{1 D} {\hat{y}}_{1} ( {\hat{y}}_{1} - 1 ) & … & {x}_{ND} {\hat{y}}_{N} ( {\hat{y}}_{N} - 1 )\end{matrix} )$$

X is the joint data, T is a matrix transposition symbol, and the predictive value is ŷ_{N}=π(X_{N}).

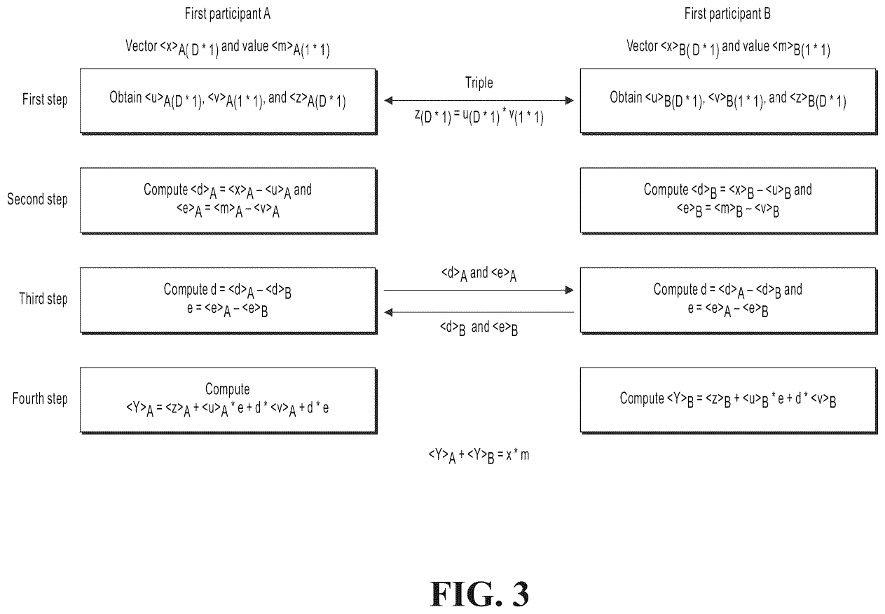

The following provides a description by using an example of a method for computing a first column of X^{T}Λ. The first column of X^{T}Λ needs to be obtained. Each element in a vector x=(x₁₁ . . . x_{1D}) needs to be multiplied by ŷ(ŷ₁−1). The multiplication operation between the first participant A and the second participant B is used as an example for description. Referring to a flowchart shown in FIG. 3, FIG. 3 is a schematic flowchart illustrating computation in application of secret sharing matrix multiplication, according to one or more embodiments.

The first participant A possesses a D*1 dimensional vector share <x>_{A} and a 1*1 dimensional value share <m>_{A}, where ŷ₁(ŷ₁−1) is replaced with m as a brief form. The second participant B possesses a D*1 dimensional vector share <x>_{B} and a 1*1 dimensional value share <m>B.

In a first step, both parties respectively obtain random number triples (triple). The first participant A obtains <u>_{A(D*1)}, <v>_{A(1*1)}, and <z>_{A(D*1)}, the second participant B obtains <u>_{B(D*1)}, <v>_{B(1*1)}, and <z>_{B(D*1)}, where z_{(D*1)}=u_{(D*1)}*v_{(1*1)} is satisfied. z=<z>_{A}+<z>_{B}, u=<u>_{A}+<u>_{B}, v=<v>_{A}+<v>_{B}. D*1 and 1*1 are the dimensionality of a matrix.

In a second step, the first participant A uses random numbers to split private data thereof to achieve the masking of the private data and thus obtain a steganographic matrix. The first participant A computes <d>_{A}=<x>_{A}−<u>_{A} and <e>_{A}=<m>_{A}−<v>_{A}. The second participant B uses random numbers to split privacy data thereof to obtain a steganographic matrix. The second participant B computes <d>_{B}=<x>_{B}−<u>_{B} and <e>_{B}=<m>_{B}−<v>_{B}.

In a third step, the participants send respective steganographic matrices thereof to each other and perform processing based on the steganographic matrices thereof and received steganographic matrices. The first participant A sends <d>_{A} and <e>_{A} to the second participant B and the second participant B sends <d>_{B} and <e>_{B} to the first participant A. The first participant A computes d=<d>_{A}−<d>_{B} and e=<e>_{A}−<e>_{B} and the first participant B computes d=<d>_{A}<d>_{B} and e=<e>_{A}−<e>_{B}.

In a fourth step, the participants respectively compute respective data shares. The first participant A computes <Y>A=<z>_{A}+<u>_{A}*e+d*<v>_{A}+d*e and the second participant B computes <Y>_{B}=<z>_{B}+<u>_{B}*e+d*<v>_{B}. <Y>_{A}+<Y>_{B}=x*m.

In this way, the first participant A and the second participant B respectively obtain the shares <Y>_{A} and <Y>_{B} without exposing the privacy data <x>_{A} and <m>_{A} and the privacy data <x>_{B} and <m>_{B}. A product of a vector x and a value m can be obtained under hypothetical reconstruction of the two shares. In addition, for each matrix multiplication, the amount of communication between the participants includes data communication 2(D+1) performed in the third step above, and an amount of communication needed to compute X^{T}Λ is 2(D+1)*N. It reduces a large amount of communication compared with an amount 2(D*N+N*N) of communication needed for general matrix multiplication computation.

Based on the above method, the plurality of participants multiply each column in X^{T} by a corresponding diagonal element in A. Any one of the participants can obtain a plurality of shares <Y>_{A}. A matrix constructed by splicing the plurality of shares <Y>_{A} together is a share of X^{T}Λ in the participant.

After performing joint computation to obtain X^{T}Λ, the plurality of participants can use SMM to determine shares of the Hessian matrix H=X^{T}ΛX based on <X^{T}Λ> shares and the joint data shares <X> that are respectively possessed by the plurality of participants.

The following describes a process of using SMM to perform share matrix multiplication by using an example of two participants. It is known that the first participant A possesses the share <X^{T}Λ>_{A} and the joint data share <X>_{A}, the second participant B possesses the share <X^{T}Λ>_{B} and the joint data share <X>_{B}, a goal is to output X^{T}ΛX so that the first participant obtains <X^{T}ΛX>_{A} and the second participant B obtains <X^{T}ΛX>_{B}, and <X^{T}ΛX>_{A}+<X^{T}ΛX>_{B}=X^{T}ΛX.

For a processing process between the first participant A and the second participant B, reference can be made to the schematic diagram described in FIG. 3. Data <x>_{A} of the first participant A in FIG. 3 are replaced with <X^{T}Λ>_{A}, <m>_{A} is replaced with <x>_{A}, data <x>_{B} of the second participant B are replaced with <X^{T}Λ>_{B}, <m>_{B} is replaced with <x>_{B}, and matrix dimensions of respective parameters are adjusted accordingly. In this way, the first participant A and the second participant B can respectively obtain the Hessian matrix shares <X^{T}ΛX>_{A} and <X^{T}ΛX>_{B} based on the flowchart shown in FIG. 3. In FIG. 3, <X^{T}ΛX>_{A} corresponds to <Y>_{A} and <X^{T}ΛX>_{B} corresponds to <Y>_{B}.

Operations performed by the first participant A and the second participant B are respectively performed by participant devices that correspond to the participants in actual operations.

Next, referring back to step 2, when the step that intermediate matrix inverse shares <H⁻¹> that respectively correspond to the plurality of participants are computed based on the intermediate matrix shares <H> of the plurality of participants, to obtain covariance matrix shares <Cov> that respectively correspond to the plurality of participants is performed, iterative computation can be performed based on the intermediate matrix shares <H> of the plurality of participants by using a secret sharing matrix inverse (Secure Matrix Inverse, SMI) algorithm, to obtain the covariance matrix shares <Cov> that respectively correspond to the plurality of participants. The covariance matrix is equal to an intermediate matrix inverse, that is, Cov=H⁻¹.

For example, the intermediate matrix share <H>_{A} of the first participant A and the intermediate matrix share <H>_{B} of the second participant B are known. To obtain <H⁻¹>_{A} and <H ¹>_{B} through computation, iterative computation can be performed by using SMI. The intermediate matrix H is obtained under hypothetical reconstruction of the intermediate matrix shares <H>_{A} and <H>_{B}. H⁻¹ is an inverse matrix of H. However, the first participant A and the second participant B do not reconstruct H. Therefore, the first participant A and the second participant B need to be enabled to respectively determine <H⁻¹>_{A} and <H⁻¹>_{B} when <H>_{A} and <H>_{B} are known and are not reconstructed. Leakage of private data can be avoided without reconstructing the intermediate matrix H.

The following describes, by using an example of two participants, a process of obtaining the covariance matrix share through iterative computation by using SMI. It is known that the first participant A possesses the intermediate matrix share <H>_{A} and the second participant B possesses the intermediate matrix share <H>_{B}, where H=<H>_{A}+<H>_{B}. Expectation: The first participant A is enabled to obtain <H⁻¹>_{A}, and the second participant B is enabled to obtain <H⁻¹>_{B}, where H⁻¹=<H¹>_{A}+<H¹>_{B}.

When initialization is performed, the first participant A and the second participant B separately obtain L0 through joint computation.

$${L}_{0} = t {r ( H )}^{- 1} = {[ t r ( < H {>}_{A} ) + t r ( < H {>}_{B} ) ]}^{- 1}$$

tr is a trace of the matrix.

In any iterative computation, the plurality of participants respectively perform computation by using SMM based on an iteration equation below:

$${L}_{k + 1} = {L}_{k} ( 2 * I - {HL}_{k} ) = ( < {L}_{k} {>}_{A} + < {L}_{k} {>}_{B} ) [ 2 * I - ( < H {>}_{A} + < H {>}_{B} ) ( < {L}_{k} {>}_{A} + < {L}_{k} {>}_{B} ) ]$$

I is an identity matrix. In an iteration process, SMM needs to be performed twice. A quantity of iteration rounds can be pre-determined, for example, can be set to 20 to 32, and k is a quantity of iterations.

Referring back to step S230, when the effective value, of the feature term that corresponds to the model parameter, in improving the effect of the business prediction model is determined based on the model parameter shares of the plurality of participants and the covariance matrix shares, Equation (2) for the Wald test can be used:

$${Wald}_{k} = {( \frac{{\hat{β}}_{k}}{SE ( {\hat{β}}_{k} )} )}^{2}$$

Alternatively, Equation (8) is used:

$${z}_{k} = \frac{{\hat{β}}_{k}}{SE ( {\hat{β}}_{k} )}$$

A significance test value (or a significance level value) for a k^{th} model parameter is computed, and an effective value, of a feature term that corresponds to the model parameter, in improving the effect of the business prediction model is determined based on the significance test value and an initial hypothesis.

When Waldₖ or zₖ is determined, a numerator part is a model parameter \hat{β}ₖ, a denominator part SE(\hat{β}ₖ) is a standard deviation of the model parameter, the model parameter can be derived from a square root of a variance of the model parameter, and a diagonal element of the covariance matrix is the corresponding variance of the model parameter. In the following, an effective value of a feature term corresponding to the model parameter can be determined based on the model parameter shares of the plurality of participants and the covariance matrix shares by using a secret sharing inverse square root (Secure Number Sqrt Invert, SNSI) algorithm. Specifically, it can include step 1b and step 2b below.

Step 1b: The plurality of participant devices use diagonal elements in the covariance matrix shares of the plurality of participants as variance shares that respectively correspond to a plurality of model parameters. Here, the diagonal element can be a main diagonal element. In the covariance matrix, a main diagonal element is a variance of the feature term. Corresponding, in the covariance matrix share, the main diagonal element is a variance share of the feature term.

Step 2b: The first participant device determines, for any one of the model parameters, a significance test value share of the first participant A for the model parameter by jointly performing a secure inverse square root operation through interaction between the plurality of participant devices based on the corresponding model parameter share of the first participant A and the corresponding variance shares of the plurality of participants by using the SNSI algorithm and the significance test method; and determines, based on significance test value shares of the plurality of participants for the model parameter, an effective value of the feature term corresponding to the model parameter.

Similarly, the second participant device determines, for any one of the model parameters, a significance test value share of the second participant B for the model parameter by jointly performing a secure inverse square root operation through interaction between the plurality of participant devices based on the corresponding model parameter share of the second participant B and the corresponding variance shares of the plurality of participants by using the SNSI algorithm and the significance test method.

In an implementation, significance test value shares of the plurality of participants can be sent to a certain participant device or a third-party device, and can be reconstructed by the participant device or the third-party device to obtain the significance test value. An effective value of a corresponding feature term can be determined based on the significance test value in accordance with a predetermined transformation method. In another implementation, alternatively, significance test value shares of the plurality of participants can be directly used as effective value shares, and a plurality of significance test value shares can be reconstructed to obtain the effective value.

The significance test value can be computed based on Equation (2), Equation (8), or the p_value equation, and an obtained significance test value share can be, but is not limited to, a Waldₖ value share, a zₖ value share, or a p-value share.

The model parameter is obtained under hypothetical reconstruction of the model parameter shares of the plurality of participants. For example, for any model parameter β₁, the model parameter β₁ is obtained under hypothetical reconstruction of a model parameter share <β₁>_{A} of the first participant and a model parameter share <β₁>_{B} of the second participant B. The model parameter shares are not really reconstructed; here, it is only to describe a relationship between the model parameter shares and the model parameter.

It can be seen that, in the embodiments, the diagonal elements in the covariance matrix shares of the plurality of participants are used when the significance test value is computed, and data in the covariance matrix are not reconstructed. Therefore, the security of the private data in the covariance matrix can be well protected.

The following describes in detail the step 2b that the first participant device determines, for any model parameter βₖ, a significance test value share of the first participant A for the model parameter βₖ by jointly performing a secure inverse square root operation through interaction between the plurality of participant devices based on the model parameter share <βₖ>_{A}of the first participant A and the variance shares of the plurality of participants by using the SNSI algorithm and the significance test method in step 2b. Similarly, the significance test value share, of the second participant B for the model parameter βₖ, determined by the second participant device can be obtained.

Equation (8), that is,

$${z}_{k} = \frac{{\hat{β}}_{k}}{SE ( {\hat{β}}_{k} )} ,$$

in the significance test method is used as an example. For the first participant, Equation (8) can be transformed into:

$$< {z}_{k} {>}_{A} = \frac{< {\hat{β}}_{k} {>}_{A}}{\overline{\sqrt{< {Cov}_{kk} {>}_{A} + < {Cov}_{kk} {>}_{B}}}} \qquad ( 12 )$$

<zₖ>_{A} is the significance test value share of the first participant A for the model parameter βₖ. A numerator part is the model parameter share of the first participant A. In a denominator part, <Covₖₖ>_{A} is the variance share that corresponds to the model parameter βₖ and that is possessed by the first participant A, and is also a kk^{th} element (diagonal element) in the covariance matrix share of the first participant A; <Covₖₖ>_{B} is the variance share that corresponds to the model parameter βₖ and that is possessed by the second participant B, and is also a kk^{th} element (diagonal element) in the covariance matrix share of the second participant B.

The first participant A possesses the numerator part, and the first participant A and the second participant B possess the denominator part together. In this case, the focus of the problem is how to compute an inverse square root in Equation (12). In the embodiments, an inverse square root of a sum of the variance share of the first participant A for the model parameter βₖ and the variance share of the second participant B for the model parameter βₖ is determined by using the SNSI algorithm, and the significance test value share of the first participant A for model parameter βₖ can be obtained based on a product of the inverse square root and the model parameter share <pk>_{A} of the first participant A. The inverse square root in Equation (12) is as follows:

$$\frac{1}{\sqrt{< {Cov}_{kk} {>}_{A} + < {Cov}_{kk} {>}_{B}}}$$

The following specifically describes, in step 1c to step 3c, how to compute the inverse square root (<Covₖₖ>_{A}+<Covₖₖ>_{B})−½ by using the SNSI algorithm. For ease of description, let nₐ=<Covₖₖ>_{A} and n_{b}=<Covₖₖ>_{B}, and let n indicate the model parameter βₖ, that is, n=nₐ+n_{b}. The following computational expectation is used so that the first participant device obtains cₐ, the second participant device obtains c_{b}, and cₐ+c_{b}=(nₐ+n_{b})_{-1/2}=n^{-1/2}.

Step 1c: The first participant device and the second participant device convert, through interaction, an additive share into a multiplicative share.

The first participant device locally generates a random number xₐ, and computes

$${x}_{a}^{- 1} , where {x}_{ba 1} = {c}_{a} \times {x}_{a}^{- 1} .$$

The first participant device and the second participant device jointly compute

$${x}_{a}^{- 1} \times {n}_{b}$$

through secret sharing matrix multiplication, to respectively obtain x_{ba2} and x_{bb}.

The first participant device computes x_{ba}=X_{ba1}+X_{ba2}, and sends x_{ba} to the second participant device (where x_{ba1} and x_{ba2} cannot be separately sent). The second participant device computes x_{b}=x_{ba}+X_{bb}. In this case, n=xₐ×x_{b}. In this way, the additive share n=nₐ+n_{b} is converted into the multiplicative share n=xₐ×x_{b}. In this case, the first participant A possesses xₐ and the second participant possesses x_{b}.

Step 2c: The two participant devices separately perform local initialization of an iterative estimated value.

The first participant A is used as an example. The first participant device reads a storage value of a 64-bit floating-point number xₐ in a storage method of a 64-bit integer, performs a shift right by one bit (divides it by 2 and rounds it down), and denotes it as intₐ; and computes 0x5fe6eb50c7b537a9−intₐ, reads it in a storage method of the 64-bit floating-point number, and denotes it as yₐ. In this way, xₐ is initialized to yₐ.

Similarly, the second participant device can initialize x_{b} to y_{b} by performing initialization. In this case, the first participant A possesses yₐ and the second participant possesses y_{b}.

Step 3c: The two participants jointly use the Newton method to iteratively compute n−½.

An iterative initial value is Y₀=Y₀ₐ×Y_{0b}=Yₐ×Y_{b} and is possessed by each of the two participants. An iteration equation is as follows:

$$\begin{matrix}{Y}_{k + 1} = {Y}_{k} ( \frac{3}{2} - {nY}_{k}^{2} ) = ( {Y}_{ka} \times {Y}_{kb} ) ( \frac{3}{2} - ( {x}_{a} \times {x}_{b} ) {( {Y}_{ka} \times {Y}_{kb} )}^{2} ) \\ = \frac{3}{2} {Y}_{ka} {Y}_{kb} - {x}_{a} {Y}_{ka}^{3} {x}_{b} {Y}_{kb}^{3} \\ = {c}_{a} + {c}_{b}\end{matrix}$$

Two times of secret sharing matrix multiplication is used for a total of one iteration in an iteration process, and the first participant A and the second participant B respectively obtain floating-point numbers cₐ and c_{b}.

An implementation process of step 2b can alternatively be implemented by using another method. For example, the variance share of the first participant A and the variance share of the second participant B are first securely normalized, then the iterative initial value is obtained through linear approximation computation, and finally an iteration is performed based on the Goldschmidt algorithm. In this implementation, a secret sharing matrix multiplication operation can be performed based on the variance share of the first participant A and the variance share of the second participant B before other operations are performed.

In this specification, “first” in the first participant and the first feature term, and “second” in the text are used only for ease of distinction and description and do not have any limited meaning.

In this specification, a quantity of the plurality of participants can be two, three, or more. Each of the participants performs a plurality of operations through a corresponding participant device. The participant device can be implemented by using any apparatus, device, platform, or device cluster with computing and processing capabilities.

In the embodiments of this specification, two participants are mostly used as an example for description. For example, in the description of the embodiments of algorithms such as secret sharing matrix multiplication, secret sharing inverse square root, and secret sharing matrix inverse for secure multi-party computation, the implementation of the two participants can be easily extended to scenarios involving more parties. Details are omitted for a specific process.

Some specific embodiments of this specification are described in the above content, and some other embodiments fall within the scope of the appended claims. In some cases, actions or steps described in the claims can be performed in a sequence different from that in the some embodiments and desired results can still be achieved. In addition, processes described in the accompanying drawings do not necessarily need a specific order or a sequential order shown to achieve the desired results. In some implementations, multitasking and parallel processing are also possible or may be advantageous.

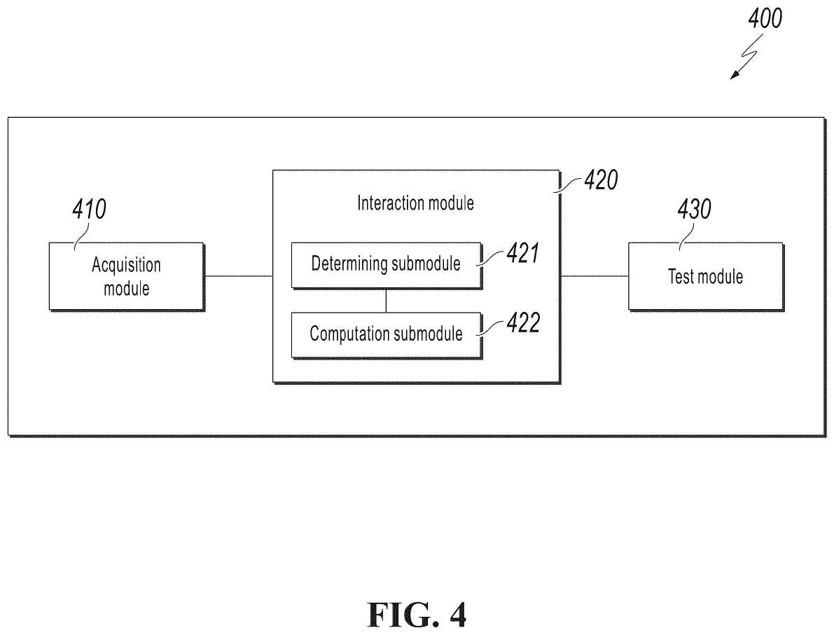

FIG. 4 is a schematic block diagram illustrating a privacy-protecting apparatus for determining a feature effective value of business data, according to one or more embodiments. The business data are distributed in a plurality of participants, joint data are constructed under hypothetical splicing of respective business data of the plurality of participants, and the joint data include feature values of a plurality of objects for a plurality of feature terms; and the apparatus 400 is deployed in any first participant device, and the first participant device can be implemented by any apparatus, device, platform, or device cluster with computing and processing capabilities. The apparatus embodiment corresponds to the method embodiment shown in FIG. 2. The apparatus 400 includes the following: an acquisition module 410 configured to obtain a joint data share of a first participant, and obtain predictive value shares that respectively correspond to the plurality of objects and model parameter shares that respectively correspond to the plurality of feature terms, where the predictive value shares and the model parameter shares are obtained based on a trained business prediction model; an interaction module 420 configured to determine, based on joint data shares and predictive value shares of the plurality of participants through interaction between a plurality of participant devices through secure multi-party computation, correlation data shares that respectively correspond to the plurality of participants, where the correlation data share includes correlation data between the plurality of feature terms; and a test module 430 configured to determine, based on model parameter shares of the plurality of participants and corresponding data in the correlation data shares through secure interaction between the plurality of participant devices by using a significance test method, an effective value, of a feature term that corresponds to a model parameter, in improving an effect of the business prediction model.

In an implementation, the acquisition module 410 obtains the joint data share of the first participant, including: a splitting operation and a splicing operation are performed based on the business data of the plurality of participants through interaction with another participant device through additive secret sharing, so that the plurality of participants respectively obtain the joint data shares; and the joint data are obtained under hypothetical reconstruction of the joint data shares of the plurality of participants.

In an implementation, the business prediction model is obtained based on secure joint training of the respective joint data shares of the plurality of participants, and the business prediction model is used to perform business prediction on the object.

In an implementation, the acquisition module 410 obtains the predictive value shares that respectively correspond to the plurality of objects and the model parameter shares that respectively correspond to the plurality of feature terms, including: a local model parameter share of the trained business prediction model is obtained on the first participant device; and the plurality of participants are respectively enabled to determine the predictive value shares of the objects based on the joint data shares of the plurality of participants and the trained business prediction model through interaction between the plurality of participant devices.

In an implementation, the correlation data include covariance matrix data, and the correlation data share includes a covariance matrix share; and the interaction module 420 includes the following: a determining submodule 421 configured to determine, based on the joint data shares and the predictive value shares of the plurality of participants and a function relation in the business prediction model, intermediate matrix shares that respectively correspond to the plurality of participants; and a computation submodule 422 configured to compute, based on the intermediate matrix shares of the plurality of participants, intermediate matrix inverse shares that respectively correspond to the plurality of participants, to obtain covariance matrix shares that respectively correspond to the plurality of participants.

In an implementation, the determining submodule 421 is specifically configured to determine, as the intermediate matrix shares based on the joint data shares and the predictive value shares of the plurality of participants and a Hessian matrix expression obtained based on the function relation in the business prediction model, Hessian matrix shares that respectively correspond to the plurality of participants, where the Hessian matrix expression includes a joint data matrix and a predictive value matrix.

In an implementation, the determining submodule 421 determines the Hessian matrix shares that respectively correspond to the plurality of participants, including the following: Corresponding multiplication of vector elements is performed on the predictive value shares of the plurality of participants based on an expression of the predictive value matrix through multiplicative secret sharing, so that the plurality of participants respectively obtain intermediate vector shares; construction is performed by using elements in the intermediate vector share of the first participant as diagonal elements, to obtain a diagonalized predictive value matrix share of the first participant; and the Hessian matrix shares that respectively correspond to the plurality of participants are determined based on the joint data shares and predictive value matrix shares of the plurality of participants and the Hessian matrix expression.

In an implementation, the determining submodule 421 determines the Hessian matrix shares that respectively correspond to the plurality of participants based on the joint data shares and predictive value matrix shares of the plurality of participants and the Hessian matrix expression, including the following: A secure multiplication operation is respectively performed on column vectors in the joint data share with corresponding diagonal elements in the predictive value matrix share when the secure multiplication operation on the joint data shares with the predictive value matrix shares of the plurality of participants is computed.

In an implementation, the computation submodule 422 is specifically configured to perform iterative computation based on the intermediate matrix shares of the plurality of participants by using a secret sharing matrix inverse (SMI) algorithm, to obtain the covariance matrix shares that respectively correspond to the plurality of participants.

In an implementation, the test module 430 is specifically configured to use diagonal elements in the covariance matrix shares of the plurality of participants as variance shares that respectively correspond to a plurality of model parameters; determine, for any one of the model parameters, a significance test value share of the first participant for the model parameter by jointly performing a secure inverse square root operation through interaction between the plurality of participant devices based on the corresponding model parameter share of the first participant and the corresponding variance shares of the plurality of participants by using SNSI and the significance test method; and determine, based on significance test value shares of the plurality of participants for the model parameter, an effective value of the feature term corresponding to the model parameter.

In an implementation, the apparatus 400 further includes a reconstruction module (not shown in the figure) configured to obtain, for any first feature term, an effective value share of the first feature term from another participant device; and determine, based on a local effective value share of the first feature term and the obtained effective value share, an effective value, of the first feature term, after reconstruction.

In an implementation, the apparatus 400 further includes a removing module (not shown in the figure) configured to remove a feature term whose effective value does not satisfy a predetermined condition from the plurality of feature terms based on the effective value, so that the plurality of participants perform secure joint training on the business prediction model by using business data obtained after the feature term is removed.

In an implementation, the object includes one of a user, a product, or an event; the feature term includes at least one of the following: basic attribute information, association relationship information, interaction information, or historical behavior information; and the business prediction model is used to perform business prediction on the object.

In an implementation, the business prediction model is obtained based on a logistic regression model.

The above some apparatus embodiments correspond to the some method embodiments. For detailed description, references can be made to the description of the part of the some method embodiments, and details are omitted for simplicity. The some apparatus embodiments are obtained based on the corresponding some method embodiments, and have the same technical effects as the corresponding some method embodiments. For detailed description, references can be made to the corresponding some method embodiments.

One or more embodiments of this specification further provide a computer-readable storage medium. The computer-readable storage medium stores a computer program. When the computer program is executed on a computer, the computer is enabled to perform the method in any of FIG. 1 to FIG. 3.

One or more embodiments of this specification further provide a computing device, including a memory and processor. The memory stores executable code, and the processor executes the executable code, to implement the method in any of FIG. 1 to FIG. 3.

The embodiments in this specification are described in a progressive way. For same or similar parts of the embodiments, references can be made to the embodiments mutually. Each embodiment focuses on a difference from other embodiments. Particularly, some storage medium embodiments and some computing device embodiments are basically similar to the some method embodiments, and therefore are described briefly. For a related part, references can be made to the corresponding descriptions in the same method embodiments.

A person skilled in the art should be aware that in the above-mentioned one or more examples, functions described in some embodiments of this application can be implemented by hardware, software, firmware, or any combination thereof. When implemented by using software, these functions can be stored in a computer-readable medium or transmitted as one or more instructions or code on a computer-readable medium.

The objectives, technical solutions, and beneficial effects of some embodiments of this application have been described in more detail with reference to the above-mentioned some specific implementations. It should be understood that the above-mentioned descriptions are merely some specific implementations of some embodiments of this application and are not intended to limit the protection scope of this application. Any modification, equivalent replacement, or improvement made based on the technical solutions of this application shall fall within the protection scope of this application.

What is claimed is:

1. A computer-implemented method, comprising:
obtaining, by a first participant of a plurality of participants, a joint data share, a predictive value share, and a model parameter share, wherein:
the joint data share is obtained based on joint data, which is generated from data of the plurality of participants by hypothetical splicing and comprises feature values of a plurality of objects corresponding to a plurality of feature terms;
the predictive value share is obtained based on predictive values for the plurality of objects, which are determined by a prediction model based on the joint data; and
the model parameter share is obtained based on model parameters, corresponding to the plurality of feature terms respectively, of the prediction model;
determining, by the first participant performing secure multi-party computation with other participants and based on the joint data shares and the predictive value shares, a correlation data share, wherein the correlation data share comprises correlation data between the plurality of feature terms, and wherein the correlation data comprises covariance matrix data, and the correlation data share comprises covariance matrix share, and determining the correlation data share comprises:
determining, based on the joint data shares, the predictive values, and a function relation in the prediction model, a plurality of intermediate matrix shares corresponding to the plurality of participants, wherein the plurality of joint data shares are configured to generate the joint data based on a hypothetical reconstruction of the predictive value shares of the plurality of participants;
obtaining, based on the plurality of intermediate matrix shares, a plurality of intermediate matrix inverse shares corresponding to the plurality of participants; and
obtaining, based on the plurality of intermediate matrix inverse shares, a plurality of covariance matrix shares corresponding to the plurality of participants; and
determining, by the first participant interacting with the other participants and based on the model parameter shares and the correlation data shares, an effective value of the feature term using a significance test method, wherein the effective value indicates an effectiveness of the feature term in improving the prediction model.

2. The computer-implemented method of claim 1, wherein obtaining the joint data share comprises:
performing, based on the data of the plurality of participants and by using additive secret sharing, a splitting operation and a splicing operation to obtain the plurality of joint data shares for the plurality of participants, wherein the plurality of joint data shares are configured to generate the joint data based on hypothetical reconstruction.

3. The computer-implemented method of claim 1, wherein the prediction model is obtained based on secure joint training of a plurality of joint data shares, and the prediction model is configured to perform prediction on the plurality of objects.

4. The computer-implemented method of claim 3, wherein obtaining the predictive value share and the model parameter share comprises:
obtaining a local model parameter share of the prediction model on a device of the first participant, as the model parameter share; and
interacting with the other participants of the plurality of participants to determine, based on the plurality of joint data shares and the prediction model, the predictive value shares.

5. The computer-implemented method of claim 1, wherein determining the plurality of intermediate matrix shares comprises:
determining, based on the predictive value shares, and a Hessian matrix expression obtained based on function relations in the prediction model, a plurality of Hessian matrix shares corresponding to the plurality of participants, wherein the Hessian matrix expression comprises a joint data matrix and a predictive value matrix.

6. The computer-implemented method of claim 5, wherein determining the plurality of Hessian matrix shares comprises:
obtaining a plurality of intermediate vector shares corresponding to the plurality of participants by performing, by using multiplicative secret sharing, multiplication of the plurality of predictive value shares based on an expression of the predictive value matrix; and
obtaining a diagonalized predictive value matrix share of the first participant by using elements in an intermediate vector share of the first participant as diagonal elements.

7. The computer-implemented method of claim 6, wherein determining the plurality of Hessian matrix shares comprises:
performing secure multiplication operations respectively on column vectors in the joint data share of the plurality of joint data shares with corresponding diagonal elements in a predictive value matrix share.

8. The computer-implemented method of claim 1, wherein obtaining the plurality of covariance matrix shares comprises:
performing iterative computation by using a secret sharing matrix inverse (SMI) algorithm based on the plurality of intermediate matrix shares.

9. The computer-implemented method of claim 1, wherein determining the effective value of the feature term comprises:
using diagonal elements in the covariance matrix shares as variance shares corresponding to a plurality of model parameters;
obtaining a significance test value share of the first participant for a model parameter of the plurality of model parameters by performing, based on a model parameter share of the first participant and the variance shares, a secure inverse square root operation using a secret sharing inverse square root (SNSI) algorithm and the significance test method; and
determining, based on significance test value shares of the plurality of participants for the model parameter, the effective value of the feature term corresponding to the model parameter.

10. The computer-implemented method of claim 9, further comprising:
obtaining, for a first feature term, effective value shares of the first feature term from devices of participants other than the first participant; and
determining a reconstructed effective value of the first feature term based on the effective value shares and a local effective value of the first feature term on a device of the first participant.

11. The computer-implemented method of claim 1, further comprising:
removing a feature term that does not satisfy a predetermined condition from the plurality of feature terms based on the effective value.

12. The computer-implemented method of claim 1, wherein the plurality of objects comprise one of a user, a product, or an event, wherein the plurality of feature terms comprise at least one of: basic attribute information, association relationship information, interaction information, or historical behavior information, and wherein the prediction model is configured to perform prediction on the plurality of objects.

13. The computer-implemented method of claim 1, wherein the prediction model is obtained based on a logistic regression model.

14. A non-transitory, computer-readable medium storing one or more instructions executable by a computer system to perform operations comprising:
obtaining, by a first participant of a plurality of participants, a joint data share, a predictive value share, and a model parameter share, wherein:
the joint data share is obtained based on joint data, which is generated from data of the plurality of participants by hypothetical splicing and comprises feature values of a plurality of objects corresponding to a plurality of feature terms;
the predictive value share is obtained based on predictive values for the plurality of objects, which are determined by a prediction model based on the joint data; and
the model parameter share is obtained based on model parameters, corresponding to the plurality of feature terms respectively, of the prediction model;
determining, by the first participant performing secure multi-party computation with other participants and based on the joint data shares and the predictive value shares, a correlation data share, wherein the correlation data share comprises correlation data between the plurality of feature terms, and wherein the correlation data comprises covariance matrix data, and the correlation data share comprises covariance matrix share, and determining the correlation data share comprises:
determining, based on the joint data shares, the predictive values, and a function relation in the prediction model, a plurality of intermediate matrix shares corresponding to the plurality of participants, wherein the plurality of joint data shares are configured to generate the joint data based on a hypothetical reconstruction of the predictive value shares of the plurality of participants;
obtaining, based on the plurality of intermediate matrix shares, a plurality of intermediate matrix inverse shares corresponding to the plurality of participants; and
obtaining, based on the plurality of intermediate matrix inverse shares, a plurality of covariance matrix shares corresponding to the plurality of participants; and
determining, by the first participant interacting with the other participants and based on the model parameter shares and the correlation data shares, an effective value of the feature term using a significance test method, wherein the effective value indicates an effectiveness of the feature term in improving the prediction model.

15. The non-transitory, computer-readable medium of claim 14, wherein obtaining the joint data share comprises:
performing, based on the data of the plurality of participants and by using additive secret sharing, a splitting operation and a splicing operation to obtain a plurality of joint data shares for the plurality of participants, wherein the plurality of joint data shares are configured to generate the joint data based on hypothetical reconstruction.

16. The non-transitory, computer-readable medium of claim 14, wherein the prediction model is obtained based on secure joint training of a plurality of joint data shares, and the prediction model is configured to perform prediction on the plurality of objects.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining, by a first participant of a plurality of participants, a joint data share, a predictive value share, and a model parameter share, wherein:
the joint data share is obtained based on joint data, which is generated from data of the plurality of participants by hypothetical splicing and comprises feature values of a plurality of objects corresponding to a plurality of feature terms;
the predictive value share is obtained based on predictive values for the plurality of objects, which are determined by a prediction model based on the joint data; and
the model parameter share is obtained based on model parameters, corresponding to the plurality of feature terms respectively, of the prediction model;
determining, by the first participant performing secure multi-party computation with other participants and based on the joint data shares and the predictive value shares, a correlation data share, wherein the correlation data share comprises correlation data between the plurality of feature terms, and wherein the correlation data comprises covariance matrix data, and the correlation data share comprises covariance matrix share, and determining the correlation data share comprises:
determining, based on the joint data shares, the predictive values, and a function relation in the prediction model, a plurality of intermediate matrix shares corresponding to the plurality of participants, wherein the plurality of joint data shares are configured to generate the joint data based on a hypothetical reconstruction of the predictive value shares of the plurality of participants;
obtaining, based on the plurality of intermediate matrix shares, a plurality of intermediate matrix inverse shares corresponding to the plurality of participants; and
obtaining, based on the plurality of intermediate matrix inverse shares, a plurality of covariance matrix shares corresponding to the plurality of participants; and
determining, by the first participant interacting with the other participants and based on the model parameter shares and the correlation data shares, an effective value of the feature term using a significance test method, wherein the effective value indicates an effectiveness of the feature term in improving the prediction model.

18. The computer-implemented system of claim 17, wherein obtaining the predictive value share and the model parameter share comprises:
obtaining a local model parameter share of the prediction model on a device of the first participant, as the model parameter share; and
interacting with other participants of the plurality of participants to determine, based on a plurality of joint data shares and the prediction model, a plurality of predictive value shares.

19. The computer-implemented system of claim 17, wherein obtaining the joint data share comprises:
performing, based on the data of the plurality of participants and by using additive secret sharing, a splitting operation and a splicing operation to obtain a plurality of joint data shares for the plurality of participants, wherein the plurality of joint data shares are configured to generate the joint data based on hypothetical reconstruction.

20. The computer-implemented system of claim 17, wherein the prediction model is obtained based on secure joint training of a plurality of joint data shares, and the prediction model is configured to perform prediction on the plurality of objects.
